(19) United States
(12) Patent Application Publication
(10) Pub. No.: US 2006/0193354 A1
(43) Pub. Date: Aug. 31, 2006

(54) External Cavity Tunable Laser and Control

(76) Inventor: Yehuda Rosenblatt, Holon (IL)

Correspondence Address: David Rosenblatt, D. N. Hamerkaz, Kfar Daniel, IL

(21) Appl. No.: 10/545,862

(22) PCT Filed: Feb. 5, 2004
(86) PCT No.: PCT/IL04/00115

§ 371 Date: Aug. 16, 2005

Related U.S. Application Data
(60) Provisional application No. 60/444,980, filed on Feb. 5, 2003.

(51) Int. Cl. H01S 3/13; H01S 3/08

(52) U.S. Cl. 372/29.023; 372/102; 372/98

(57) ABSTRACT

An optical lasing device, comprising (i) a lasing medium disposed in a lasing cavity, (ii) an etalon disposed within the lasing cavity, and (iii) an electrically tuned filter device, such as a grating waveguide structure device. The lasing device also comprises a detector for determining the lasing power of the lasing device, and a controllable phase shift capability, and the device is preferably locked to a maximum of the lasing power by adjusting the phase, thereby achieving locking to a wavelength predetermined by the etalon, aligned to an ITU grid wavelength. Adjusting the phase shift to achieve the maximum of the lasing power is preferably performed using a closed loop system. Furthermore, adjusting of the phase shift to achieve a maximum of the lasing power is preferably also operative to wave lock the lasing device to a peak wavelength of the etalon.

### FIELD OF THE INVENTION

The present invention relates to the field of external cavity, tunable lasers and their control systems, and especially external cavity diode tunable lasers using an active tunable mirror for high speed tuning applications, such as in optical communications networks.

### BACKGROUND OF THE INVENTION

In recent years, there has been a growing interest in tunable, wavelength-selective filters and sources for use in Dense Wavelength Division Multiplexing (DWDM) systems. A number of different types of such tunable laser sources are known in the prior art for use in such applications, including conventional Distributed Feedback (DFB) type lasers from suppliers such as Fujitsu, Hitachi and NEC, Distributed Bragg Reflection (DBR) or similar type lasers, such as those available from companies such as Agility Inc., and external cavity diode lasers (ECDL), such as those available from companies such as Iolon Inc. and Intel. Inc.

Conventional types of DFB and the more recent DBR laser diodes, being internal cavity lasers, suffer from a number of comparative disadvantages compared to ECDL's. Advanced DFB lasers suffer, from low tunability, typically of 4-16 channels only, and low switching speeds of the order of a few milliseconds, since tuning is performed thermally. The DBR or GSCR type of laser sources can be tuned over a large range of wavelengths, typically 10 to 40 nm., and can be tuned rapidly since the tuning mechanism is not thermal, but they have low power outputs, poor Relative Interference Noise (RIN), relatively wide linewidth, and generally have complicated control systems because of the interaction that takes place between the various sections, and they may have serious aging problems.

Two different approaches have been used in the construction of external cavity diode lasers. In the ECDL's supplied by Iolon, a Littman configuration is used with a Micro Electro-Mechanical System device (MEMS) to provide the motion to tune the laser by tilting the wavelength selecting grating. However, such a design may suffer from reliability problems because of the moving parts involve, even if in MEMS form, and the control system required may be complex. In the Intel/New Focus ECDL, the laser contains two etalons, which are used to select the desired wavelength by using the differential thermal expansion motion between the two etalons. In this case also, the control system may be complex and since the tuning is done thermally, low tuning speeds of the order of several seconds are achieved, which may be suitable for some current applications but which are totally unsuitable for more advanced applications of such lasers, such as SONET applications with a recovery time of 50 msec.

Furthermore, such ECDL's may display significant sensitivity to packaging tolerances and to thermal and mechanical deformations errors, which may present problems in providing stable and predictable operation over a wide range of conditions.

In U.S. Pat. No. 6,215,928, licensed to the assignee of the present application, there is described an ECDL utilizing an electrically controlled grating waveguide structure (GWS) as the rear mirror of the cavity, such that adjustment of the GWS enables the laser output wavelength to be tuned electrically. However, this patent does not provide details of how to provide sufficiently narrow and stable lasing lines for use in DWDM applications, nor are any details provided of a laser tuning control system to enable such stable use.

There therefore exists a need for a new type of external cavity diode laser, which overcomes the disadvantages of currently available such devices, and which provides a combination of faster tuning, better stability and simpler control.

The disclosures of each of the publications mentioned in this section and in other sections of the specification, are hereby incorporated by reference, each in its entirety.

### SUMMARY OF THE INVENTION

The present invention seeks to provide a laser having an external cavity configuration, which, unlike the Littman configuration used in such prior art lasers, does not require any moving parts within the laser, and in which the intra-cavity Etalon is passive, being used to provide wavelength stability to the laser operation, rather than to tune to the desired wavelength. The emission wavelength is controlled by inserting into the laser cavity a wavelength selective active tunable mirror or filter, preferably of the grating waveguide structure type (GWS), which typically works in reflection mode only, though a transmission configuration is also possible. The various aspects of the invention are generally applicable to all types of lasers, whether solid state, liquid or gas, though the invention is mostly described in terms of diode lasers, as commonly used in optical communication systems.

The proposed tunable laser system preferably comprises, in its simplest form, a gain medium disposed between two end mirrors and an internal etalon to provide basic stability. By using a wavelength selective active tunable mirror such as a GWS, as one of these cavity mirrors, or by using the GWS as an intra-cavity filter, meaning that the filter is disposed between the cavity end reflectors, and by using the etalon both to support the GWS selection of the desired wavelength, and to stabilize the laser wavelength, the operating wavelength of the external cavity tunable laser can be controlled very precisely, and can be rapidly stabilized to the desired wavelength, generally within milliseconds. For DWDM applications, the wavelengths selected are preferably those of the International Telecommunication Union (ITU) grid, for instance, the allowed channels of the C band, or similar.

Different tunable laser architectures and specific laser control schemes are used in as to provide optimum performance of the laser in terms of its power, tunability, linewidth, RIN, and stability, the latter being especially critical for DWDM applications and the like. Though the term Grating Waveguide Structure or GWS is frequently used throughout this application to describe the tunable element used in the various embodiments of the present application, this is done for convenience only, and it is to be understood that the invention is not meant to be limited to GWS elements only, but is equally applicable to any suitable type of electronically tunable, wavelength selective, active mirror or filter element, whether a reflective narrow bandpass filter or a transmissive narrow bandstop filter.

An active wavelength selective mirror, such as that described in U.S. Pat. No. 6,215,928 is preferably used, providing tuning speeds in the range of a few milliseconds. Using a suitable mirror design and proper materials, speeds of potentially down to the microsecond level could be achieved with a wide tuning range. In order to provide optimum operating parameters, control of the laser cavity operation is based on a number of control loops operating on the lasing power, each of them a one-dimensional control algorithm, meaning that each loop controls one variable, such as a PID control loop of the power output. For the case of a laser for use in DWDM applications, typically provided parameters could be 20 mW to 30 mW or more of output power, a linewidth of 1 MHz or less, an RIN of ˜155 dB, a tuning range of 40 nm to 80 nm or even more, and close control of laser frequency. In general, the controls operate in closed loop configurations, to provide a high level of environmental stability for a long laser lifetime, unaffected by diode aging. In addition, laser architectures are provided capable of potentially reducing laser costs significantly, by decreasing the sensitivity to packaging tolerances and thermal and mechanical deformations errors.

A major feature of the present invention is the provision of a tunable laser with an etalon inserted within the cavity, and having a GWS or other reflection filter for tuning. Such a construction overcomes a number of disadvantages of prior art tunable lasers.

Some of the disadvantages of such prior art lasers arise from drawbacks in the performance of the tuned filter or GWS. Such components can suffer from the following shortcomings, which result in similar shortcomings in prior art laser performance when use is not also made of an intra-cavity etalon:

(a) The tuned wavelength is sensitive to temperature

(b) The filter reflectivity and/or bandwidth may vary over the tuning range

(c) The bandwidth may not be narrow enough to enable single mode lasing, and/or the laser will have a poor side mode suppression ratio (SMSR)

(d) The tuned wavelength may drift with time due to aging processes, either in the GWS itself or in its drive circuits.

(e) The tuned wavelength may oscillate around the tuned wavelength (spectral noise).

(f) The control circuit of the filter needs to be highly accurate in order to select a single ITU wavelength with high accuracy (˜8 pm or less) out of the band of wavelengths which can be up to 40 nm or more.

(g) The control circuits have to maintain their accuracy over a wide range of ambient temperatures (as much as ˜40° C. to +70° C.), and over periods of years.

The inclusion of an etalon within the cavity reduces the dependence of the laser performance on the above-mentioned filter shortcomings, while using the filter tuning ability as the tunable laser engine for wide the tunability. This is a result of the high stability and high spectral uniformity of the etalon, its wavelength peak locations, bandwidth, reflection and spectral shape being reasonably uniform over the laser tuning range, and a result of the relatively narrow bandwidth of the etalon with respect to the current commonly used ITU grid of 100 GHz or 50 GHz, or even with respect to the expected future use of 25 GHz channel spacing or less. Inclusion of the etalon in the cavity can also improve the SMSR and prevent multiple lasing modes. Additionally, wavelength locking can be achieved by means of simple output power monitoring, or monitoring of the cavity power and/or monitoring of the power which passes through the GWS, which is of great advantage for producing high performance and cost effective DWDM lasers. These benefits are explained below.

For incorporation of an etalon into the laser cavity, there are a number of requirements for the etalon and its mounting:

(i) The etalon temperature should be stabilized for the entire life of the laser. This requirement is also mandatory for the wavelength locker components.

(ii) An etalon with low thermal dependence, or an athermal etalon may be used to reduce or eliminate dependence on temperature.

(iii) The etalon may be tuned to match the ITU grid, preferably by means of mechanical alignment and fine thermal tuning. To maintain accurate wavelength matching, this tuning can be performed during the assembly stage of the laser, and then during its lifetime, either by control of the complete laser temperature, or by stabilizing the etalon temperature itself.

(iv) An etalon mount can be used which incorporates local heating for setting and stabilizing the etalon temperature regardless of the laser optical bench temperature, or some other method that enables control of the etalon temperature.

The inclusion of an etalon within the cavity also enables wavelength locking to be achieved by the simple methods of output power monitoring and fine adjustment of the cavity phase, such as by cavity optical length adjustment. According to this method, a control loop is used to seek one or more of the maximum output power, or the maximum cavity power, or the minimum power which passes through the GWS. Attainment of such a maximum output power point means that the laser wavelength is matched to one of the etalon peaks and is therefore matched to the selected ITU grid wavelength. Furthermore, at such a point of maximum output power, the laser working point is generally a stable one, with no danger of multi-mode operation or reduced SMSR. Wavelength locking algorithms to enable achievement of these objectives, applied according to further preferred embodiments of the present invention, are described hereinbelow, when the control loop and peak detection aspects of the laser control system are described.

Many of the above-mentioned operating advantages of lasers constructed and operative according to the various embodiments of the present invention, arise from novel methods of phase locking of the laser according to the present invention. Such phase locking enables the laser, inter alia, (i) to perform wavelength locking of the laser output to the ITU grid wavelengths, thus overcoming diode aging, thermal drift, mechanical changes, etc. that affect wavelength by causing the cavity phase to shift, and (ii) to avoid lasing instability arising from drift of the phase working point into the mode-hopping region.

The concept used according to the present invention is of closed loop control of the laser phase in order to maintain the lasing power at its peak. In order to implement a closed loop control system, a phase dither or phase nudging signal has to be injected into the laser system. The GWS utilizes an applied AC voltage for its operation, with the voltage varying from a small value to some upper value as the wavelength is tuned. This AC signal thus also induces wavelength oscillations at an AC-related frequency around the tuned wavelength. These GWS self-induced wavelength oscillations have negligible effect on the tunable laser performance, since the etalon bandwidth is much narrower than the GWS bandwidth and the etalon bandwidth is dominant.

Since the GWS self-induced wavelength-oscillations are associated with self-induced phase-oscillations, the GWS induced wavelength oscillations could be used as the dither signal for operation of the phase closed loop control system. Two closed loop approaches are possible:

(i) Monitoring the lasing power at a known location over the power waveform and making logical decisions regarding the direction and amplitude of a correction phase signal.

(ii) Inputting the lasing power signal to a Phase Locking Loop (PLL) to make these decisions

The phase oscillations within the laser cavity arising from the GWS self-induced phase oscillations, cannot be used as a dither signal, because of their varying nature as a result of the varying applied AC voltage, as mentioned above. Furthermore, at one end of the wavelength range of the GWS, the drive voltage is low, and the self-induced dither may become negligible. Therefore an external phase dither signal has to be applied to some controllable phase shifting capability within the laser system, in order to provide the required phase dither signal to maintain the phase closed-loop circuit working. This controllable phase shifting capability can either be a specific hardware component, such as the phase section of the laser diode, if such is used in the lasing system, or a phase retarder element, or it can be a procedure performed on the laser in order to generate an induced phase shift as a result of that procedure, such as temperature adjustment of the entire laser cavity, or of the lasing medium alone.

In order to overcome the GWS self-induced phase-oscillations, which in any event, may generally be present in the system even if not used for phase locking, a synchronized sampling measurement of the lasing power, synchronized with the GWS dither frequency will filter the measured waveform from the GWS dither effect and enable to accurately analyze the external dither. Such a measurement can be performed by sampling the lasing power at a point in time at which the GWS phase dither is at its lowest value, i.e. at its closest value to that of the mode-hop phase region. Use of these sampled points for input to the PLL forces the closed loop system to be at the maximum lasing power at the above point of time. This ensures that in spite of the effect of the varying amplitude of the GWS-induced phase dither, which could otherwise drive the laser into mode-hopping instability, the laser system automatically ensures achievement of peak power while maintaining a safe operating phase distance from that at the mode hopping region.

The above-described phase locking control system is valid for any type of phase disturbance that can affect the capability of accurately analyzing the external phase dither, and which could even be responsible for pushing the laser phase into the mode hop phase location. Mechanical oscillations are one example of such external phase disturbances, as they can cause the cavity phase to oscillate in sympathy.

The above-described phase locking algorithm, can be further improved by the addition of a phase-offset command to the controller of the phase close-loop, so as to offset the cavity phase at the sampling point of time in the desired direction, generally away from the mode-hopping region.

According to another preferred embodiment of the present invention, there is provided a control system for the GWS enabling the filter resonant wavelength to track the incident beam wavelength. This is useful in a laser for which another mechanism takes care of the lasing wavelength and the function of the GWS filter is to strongly suppress the side bands, while the GWS resonance wavelength is centered around the lasing wavelength. Tracking of the incident beam may also be useful in other systems for which the filter is required to clean side-bands of an incident beam.

A closed loop control of the GWS wavelength is used in order to maintain the beam power at the GWS backside at its minimum. In order to do so requires some wavelength dither or wavelength nudge signal to be injected to the GWS. The applied AC voltage of the GWS induces small wavelength oscillations around the tuned wavelength; these wavelength oscillations can be used as the required dither for applications for which the GWS is not part of the cavity. Additionally, an external dither can be injected for the tracking of the GWS.

For these applications two closed loop techniques can be used:
(i) Monitor the power at a known location over the power waveform and make logical decisions regarding the direction and amplitude of correction signal.
(ii) Applying the power signal into a PLL in order to obtain the direction and amplitude of the correction signal.

When using a GWS within a laser cavity, its wavelength oscillations have a small effect on the behavior of the tunable laser, since the etalon bandwidth is much narrower than the GWS bandwidth, the etalon being the dominant filter.

GWS small phase-oscillations within the laser cavity will cause the lasing wavelength to oscillate, such that the lasing beam power will be slightly amplitude modulated due to the presence of intra-cavity etalon in the cavity. In order to enable the GWS backside power to be accurately analyzed, since the GWS is part of the laser cavity, one must insure that the cavity phase does not affect the power used by the GWS tracking closed loop. This can be done by injecting a low frequency wavelength dither to the GWS, such that the wavelength-locking mechanism already implemented in the laser system, has enough time to settle and maintain constant phase, i.e. to ensure that the wavelength locking is fast enough to reduce the phase dither to negligible values.

The benefits of an intra-cavity etalon in a tunable filter laser can thus be summarized as follows:

(i) Increased laser wavelength stability, resulting from reduced dependency on the tunable filter accuracy, the tunable filter noise (frequency shifting), the tunable filter bandwidth and the tunable filter control accuracy and drift.

(ii) Increased SMSR due to the narrowness of the etalon bandwidth.

(iii) Elimination or reduction of the need for external wave-locking means to the ITU grid.

(iv) Wavelength locking by the simple means of power monitoring.

(v) Use of the etalon as a compact cavity folding element for output power coupling or/and power monitoring.

There is thus provided in accordance with a preferred embodiment of the present invention, an optical lasing device, comprising (i) a lasing medium disposed in a lasing cavity having an optical axis, (ii) at least one end mirror disposed in the lasing cavity, (iii) an etalon disposed within the lasing cavity, and (iv) an electrically tuned filter device, wherein the electrical tuning is achieved by electro-optical change of the optical characteristics of at least one of the materials of the filter device. In the above-described optical lasing device, the filter device is preferably a grating waveguide structure device. In accordance with one preferred embodiment of the present invention, the electrically tuned filter device is disposed with its plane essentially perpendicular to the optical axis, and in accordance with another preferred embodiment, the electrically tuned filter device is disposed with its plane at an angle of tilt from a plane perpendicular to the optical axis.

The above-described lasing device also preferably comprises a detector for determining the lasing power of the lasing device, and a controllable phase shift capability, and the lasing device is preferably locked to a maximum of the lasing power by adjusting the phase, thereby achieving locking to a wavelength predetermined by the etalon aligned to a required grid wavelength. This adjusting the phase shift to achieve the maximum of the lasing power is preferably performed using a closed loop system. Furthermore, the adjusting of the phase shift to achieve a maximum of the lasing power is preferably also operative to wave lock the lasing device to a peak wavelength of the etalon. Furthermore, the optical lasing device may also comprise a closed loop system for adjusting the phase shift to achieve the maximum of the lasing power. The closed loop system preferably utilizes phase-sensitive-detection of the lasing power using an applied AC dither signal, and the grating waveguide structure is preferably operated using an applied AC drive voltage, which acts as the dither. Alternatively and preferably, the dither may be an external AC signal at a frequency other than that of the applied AC drive voltage, the external AC signal being injected into the optical lasing device by means of the controllable phase shift capability.

In the above described devices, the controllable phase shift capability may comprise a phase section of the lasing device, or if the lasing device also comprises a thermal adjusting element, the controllable phase shift capability may arise from thermal adjustment of the lasing cavity. Alternatively, the lasing device may also comprise a thermal adjusting element attached to the lasing medium, and then the controllable phase shift capability may arise from thermal adjustment of the lasing medium. Alternatively and preferably, the controllable phase shift capability may arises from fine adjustment of the grating waveguide structure, or the lasing device may also comprises a phase retarder element, and the controllable phase shift capability arises from adjustment of the phase retarder element

There is further provided in accordance with still another preferred embodiment of the present invention, an optical lasing device as described above, and wherein the grating waveguide structure device is operative as a tunable mirror to select the lasing channel. The grating waveguide structure device may be an intra-cavity tunable transmission device to select the lasing channel. The tunable mirror may be a cavity end mirror, either a full reflector or an output coupler.

Any of the above described optical lasing devices may be either a solid state laser, or a liquid laser or a gas laser. Additionally, the filter device may have a resonance width broader than a passband of the etalon, such that the stability of the lasing device is determined by the stability of the etalon. The stability is generally the wavelength stability.

In accordance with a further preferred embodiment of the present invention, there is also provided an optical lasing device as described above, and also comprising a detector for determining the lasing power of the lasing device, and wherein the lasing device also comprises a controllable phase shift capability, and wherein the lasing device is locked to a maximum of the lasing power by adjusting the phase, to achieve operation of the lasing device at a working point immune from mode hopping. In such an optical lasing device, adjusting the phase shift to achieve operation of the lasing device at a working point immune from mode hopping may also be operative to wave lock the lasing device to a peak wavelength of the etalon. The lasing device may also preferably comprise a closed loop system for adjusting the phase shift to achieve the maximum of the lasing power, the closed loop system preferably utilizing phase-sensitive-detection of a signal representing the lasing power using an applied AC dither signal. The grating waveguide structure is preferably operated using an applied AC drive voltage, which can then act as the dither. Alternatively and preferably, the dither may be an external AC signal at a frequency other than that of the applied AC drive voltage, the external AC signal being injected into the optical lasing device by means of the controllable phase shift capability.

In the above described devices, the controllable phase shift capability may comprise a phase section of the lasing device, or if the lasing device also comprises a thermal adjusting element, the controllable phase shift capability may arise from thermal adjustment of the lasing cavity. Alternatively, the lasing device may also comprise a thermal adjusting element attached to the lasing medium, and then the controllable phase shift capability may arise from thermal adjustment of the lasing medium. Alternatively and preferably, the controllable phase shift capability may arises from fine adjustment of the grating waveguide structure, or the lasing device may also comprises a phase retarder element, and the controllable phase shift capability arises from adjustment of the phase retarder element

Additionally and preferably, the closed loop of the above-described optical lasing device may include a sample and hold capability which samples the lasing power at time points synchronized with the dither signal, the dither signal arising from the grating waveguide structure applied AC drive voltage, the time points being selected at the closest phase distance from the regions of mode hopping, to prevent the dither from inducing mode hopping in the lasing system. Alternatively, the closed loop system may utilize the detection of the direction of changes in the lasing power resulting from small applied perturbations to the tuning input.

There is even further provided in accordance with a preferred embodiment of the present invention, an optical lasing device as described above, and wherein the etalon disposed within the lasing cavity has its plane at an angle of tilt from a plane perpendicular to the optical axis, and wherein the grating waveguide structure device is such that a beam having a wavelength of the lasing device, which is reflected from the grating waveguide structure device when incident thereon at normal incidence, is transmitted therethrough when incident thereon at an angle of tilt other than normal incidence. In such an embodiment, a beam having the wavelength of the lasing device and reflected from a face of the etalon may be extracted from the cavity through the grating waveguide structure. Alternatively, such a beam may be monitored through the grating waveguide structure.

There is also provided in accordance with a further preferred embodiment of the present invention, a method of tuning a grating waveguide structure mirror, the mirror transmitting a part of an incident beam impinging thereon, comprising the steps of (i) impinging an incident beam on the mirror, (ii) performing a measurement of the part of the incident beam transmitted through the mirror, and (iii) utilizing the measurement in order to tune the mirror to a position of maximum reflection by searching for a position of minimum transmission. The step of searching for minimum transmission is preferably performed by means of a closed loop system for adjusting the applied electrical tuning input to the grating waveguide structure to determine the position of minimum transmission. The closed loop system preferably utilizes phase-sensitive-detection of the measurement using an applied AC dither signal. Since the GWS is operated using an applied AC drive voltage, the dither is preferably the applied AC drive voltage. Alternatively and preferably, the dither is an externally injected AC signal at a frequency other than that of the applied AC drive voltage, impressed upon the applied AC drive voltage. The closed loop system may preferably utilize the detection of the direction of changes in the lasing power resulting from small applied perturbations to the tuning input.

### BRIEF DESCRIPTION OF THE DRAWINGS

The present invention will be understood and appreciated more fully from the following detailed description, taken in conjunction with the drawings in which:

FIG. 1 illustrates schematically an external cavity tunable laser, constructed and operative according to a first preferred embodiment of the present invention;

FIG. 2 illustrates the laser of FIG. 1, but showing more details of a practical preferred laser configuration being a further preferred embodiment of the present invention;

FIG. 3 illustrates schematically another laser configuration, according to a further preferred embodiment of the present invention;

FIGS. 4A, 4B and 5 are schematic illustrations of lasers, according to two further preferred embodiments of the present invention, with a tilted etalon; in FIG. 4, the beam is output from the GWS filter side of the cavity, while in FIG. 5, the beam is output from the laser diode end facet;

FIG. 6 schematically illustrates another laser configuration, according to a further preferred embodiment of the present invention in which the GWS filter element is used as a folding element within the cavity in addition to being an intra-cavity tunable filter, but not as a cavity mirror;

FIG. 7 schematically illustrates another preferred laser configuration according to a further preferred embodiment of the present invention, similar to that shown in FIG. 6, but using a corner cube retro-reflector, or a cat's eye retro-reflector, as the end reflector of the cavity;

FIG. 8 schematically illustrates another preferred laser configuration according to a further preferred embodiment of the present invention, similar to that shown in FIG. 6 using the GWS as a folding mirror, but having reversed cavity geometry to that shown in FIGS. 6 and 7, and also using a cat's eye reflector as the output coupler;

FIGS. 9A to 9D illustrates graphically how the use of an etalon together with a tunable filter enables single mode operation of the laser, emphasizing the synchronization between the EC FSR and the Etalon FSR, according to a further preferred embodiment of the present invention;

FIG. 10A a schematic illustration of a prior art arrangement for tuning a GWS type of tunable filter or mirror, while FIG. 10B is a schematic illustration of a novel arrangement for tuning a GWS type of tunable filter or mirror, according to a preferred embodiment of the present invention;

FIGS. 11A and 11B are schematic illustrations of a novel arrangement for tuning a GWS type of tunable filter or mirror, according to further preferred embodiments of the present invention, in which the power transmitted through the GWS is measured, and the GWS control voltage tuned for minimum transmission;

FIG. 12 is a plot of the GWS reflection, transmission and loss as a function of wavelength;

FIG. 13 is a schematic block diagram of the control algorithm and control hardware for a tunable laser with an intra-cavity etalon and GWS filter control, constructed and operative according to another preferred embodiment of the present invention;

FIG. 14A is a block diagram of the wavelength locking circuit shown in FIG. 13;

FIG. 14B is a block diagram of the peak detecting circuit of the wavelength locking circuit of FIG. 13;

FIGS. 15A to 15C are plots showing the wavelength response of laser behavior to cavity phase oscillation, such a would be generated by synchronous noise;

FIGS. 16A-D are plots, similar to those of FIGS. 15A to 15C, but showing the effect of the cavity phase shift on the lasing power up to the mode hopping point of operation;

FIGS. 17A to 17C, which are more examples of plots of the output of the laser of FIGS. 16A-C, but in which the laser is allowed to operate too close to the mode-hopping boundary;

FIGS. 18A to 18C are plots similar to those of FIGS. 17A to 17C, but taken over a longer time scale, showing the laser output power for a slowly modulated cavity phase, such as would be obtained from a dithered control circuit laser; FIG. 18D shows a longer term plot of the laser phase shift of FIG. 18C, showing the effect of phase dither imposed on the laser cavity phase shift;

FIG. 19 is an enlarged plot of FIG. 18B showing the exact details of the changes in the laser output power arising from the sample-and-hold circuit of FIG. 14B; and

FIGS. 20A and 20B show enlarged sections of the laser power output signal, illustrating a further preferred method of locking the laser working point without the need to inject the external phase dither signal.

### DETAILED DESCRIPTION OF PREFERRED EMBODIMENTS

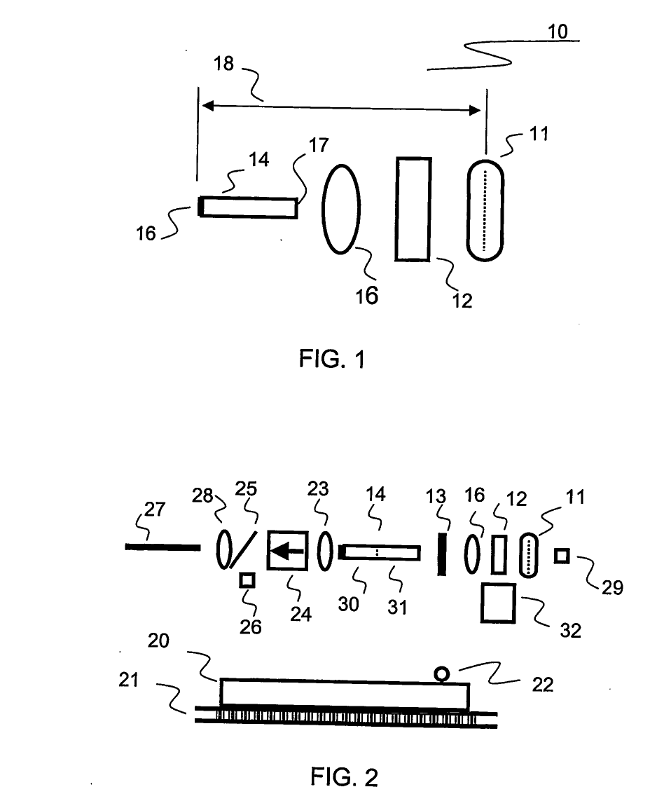

Reference is now made to FIG. 1, which illustrates schematically an External Cavity (EC) tunable laser 10, constructed and operative according to a first preferred embodiment of the present invention utilizing a tunable filter 11, such as a GWS filter, and an intra-cavity etalon 12. The laser cavity is defined by the region 18 between one end mirror 36 and the GWS element 11, with the gain medium 14 situated therein. The gain medium can be any of the common lasing media, whether solid state, gaseous or liquid. According to a most preferred embodiment, the lasing element 14 is a laser diode chip, and the end mirror 36 is then described as the front facet of the laser diode chip, and this embodiment will be generally used throughout this application to illustrate the various preferred embodiments of the present invention, though it is to be understood that the invention is not meant to be limited to such laser diodes. According to one preferred implementation of the embodiment of FIG. 1, the end mirror 36 is operative as the output coupler. The laser EC back mirror is then the tunable filter 11, which can preferably be a reflection type filter or a tunable mirror such as a Grating Wave Structure (GWS) filter, or any other suitable reflection filter. According to other preferred implementations of the embodiments of FIG. 1, the cavity configuration can be reversed, with the tunable filter or mirror 11 operative as the output coupler, while the back mirror 36 is at the far end of the lasing medium 14. Preferred examples of both of these configurations are shown hereinbelow. In general, any lasing combination of back mirrors and output couplers can be utilized in various embodiments of this invention, whether in a solid state, gas or liquid laser, the common feature being the incorporation of an intra cavity etalon, and a tunable filter device.

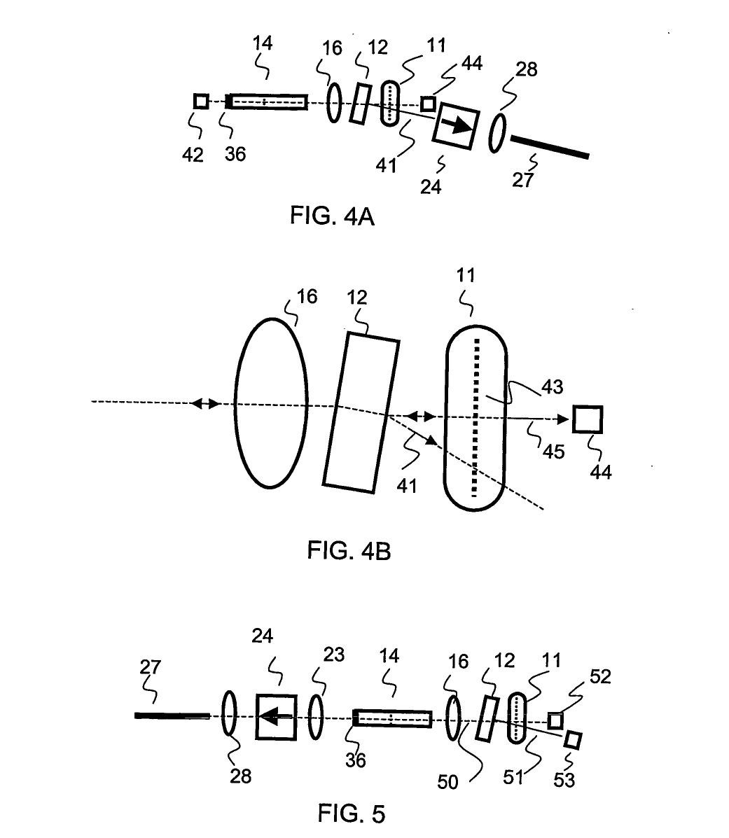

An etalon 12 is mounted inside the cavity 18. The etalon is preferably tilted slightly, of the order of one degree or so, from the perfectly perpendicular position, in order to avoid back reflection from the etalon surfaces. The tilt can be adjusted in order get match the etalon FSR with the ITU grid. This slight etalon tilt is well-known in the art, and is regarded for all practical purposes relating to the lasing system, as being essentially perpendicular to the cavity axis, and it is thuswise called in this application. This is done in order to distinguish this tilt from that of further preferred embodiments described hereinbelow in connection with the embodiments of FIGS. 4A, 4B and 5, where the etalon is tilted appreciably for the purposes described therein. A collimation lens 16 collimates the cavity beam. The back facet 17 of the diode chip 14 is preferably anti-reflection (AR) coated to minimize reflections from that facet. In order to further reduce such reflections, the facet can be provided with other than a flat surface and is known in the art as a carved diode.

Reference is now made to FIG. 2, which illustrates schematically the laser of FIG. 1, but showing more details of a practical preferred laser configuration. Items the same as those shown in previous figures are labeled with identical reference characters, as is also done throughout this application. The laser components are preferably mounted on an optical bench 20, which itself is mounted on a Thermo-Electric Cooler (TEC) 21 to maintain the desired operating temperature. A temperature monitor 22, such as a thermistor, is preferably used to measure the optical bench temperature in order to enable stabilization of the working temperature. Alternatively and preferably, the top surface of the TEC 21 can be operative as the optical bench. At the output of the laser, a collimating lens 23 is preferably used to collimate the output beam towards an optional isolator 24. The isolator prevents back-reflected power from the fiber, from re-entering the laser cavity. A beam splitting mirror 25 is preferably used to direct a small part of the output power to an output power monitor 26, which is preferably a PIN diode. Coupling of the output power into an output fiber 27 is preferably performed using a fiber lens 28. A further power detector 29, also preferably a PIN diode, is preferably located at the backside of the tunable mirror, to monitor the power transmitted through the tunable mirror. The diode chip 14 preferably has at least two sections, a gain section 30 and phase section 31, whose use in controlling the laser will be explained hereinbelow. Additionally and preferably, an adjustable phase retarder element 13 can be provided in the cavity, as an alternative method of adjusting the laser phase shift, for controlling the laser, as described hereinbelow. Additionally and preferably, if a thermal method is used to control the laser phase, a heater element 32 may be used to control and stabilize the etalon temperature.

Preferred characteristics of components used in the construction of lasers according to the above-mentioned embodiments of the present invention, typically have the following ranges of characteristics, though it is to be understood that these values are design selection parameters for specific devices, and that they are not intended to limit the invention in any manner.

Laser Diode Chip:

Gain 15-30 db
Phase tuning range 0 to 3π (round trip)
Length 0.5-1 mm
Front facet 10%-25% reflection
Threshold current 20-40 mA
Gain and phase current up to 300 mA
Back facet curved, AR coated to <0.1% reflection
Bandwidth ˜70 nm, centered around 1550 nm
   Etalon:
Free Spectral Range (FSR) 50 GHz
Bandwidth 10-20 GHz
Insertion loss<0.5 db
   GWS Mirror (for a C-Band Application):
Tuning range 1530 to 1570 nm
Bandwidth<1 nm
Working voltage 0 up to 30 Vrms
   Cavity FSR:
7-15 GHz.

Using components such as those delineated above, it is possible to construct a C-band tunable laser, constructed and operative according to the present invention, having the following performance parameters:
Tuning range 1530 to 1570 nm
ITU grid of 50 GHz, 100 GHz and 200 GHz. An ITU grid of 25 GHz or lower can be achieved using a narrower etalon and a narrower GWS bandwidth
Output power into the fiber of 13 dbm
SMSR better than 45 db
RIM better than −155 db
   It is to be understood though, that lasers having equivalent performance characteristics can also be constructed for other wavelength ranges, and this invention is not intended to be limited by the above described laser characteristics.

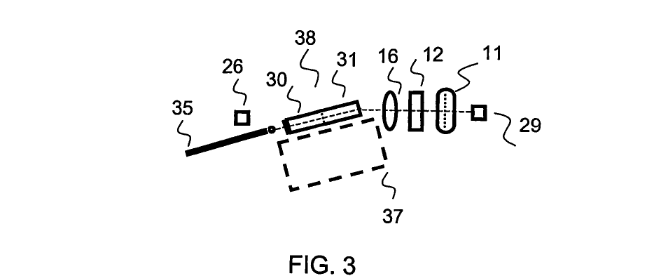

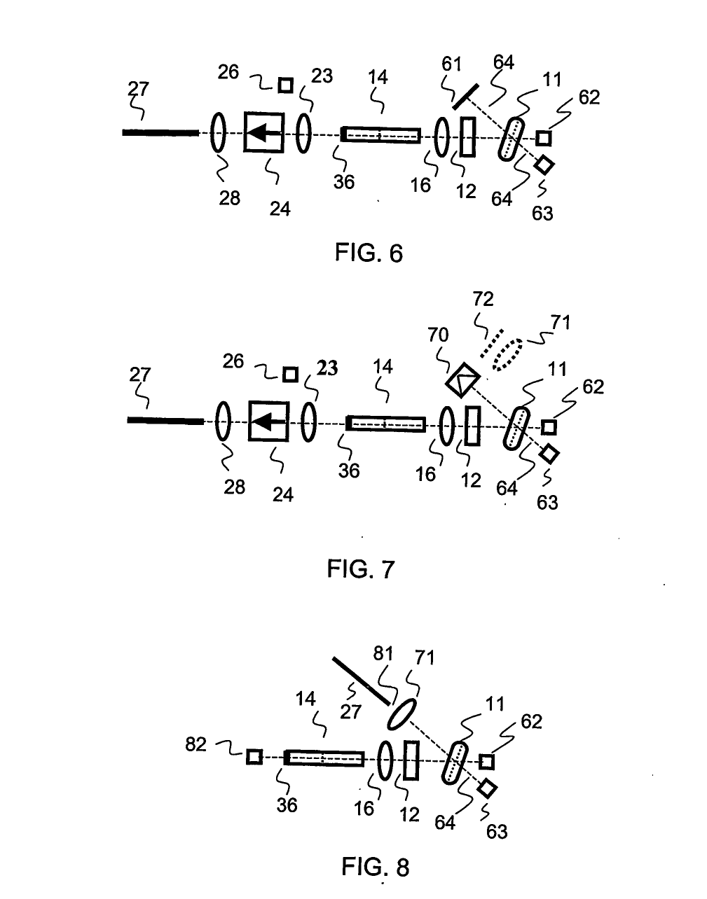

Reference is now made to FIG. 3, which illustrates schematically another laser configuration, according to a further preferred embodiment of the present invention. The laser of FIG. 3 has small number of optical elements, fewer than are shown in the embodiment of FIG. 2. Even sensor 29 can be eliminated. In the embodiment of FIG. 3, a lensed-fiber 35 and a curved diode 38 are preferably used. The use of a curved diode reduces back reflections from the diode back facet although it also causes a bend in the cavity, thereby affecting the placement of some of the laser components. The isolator 24 and hence also the collimating lens 23 and the beam splitter 25 of FIG. 2, may not be needed to ensure stable laser operation. The power monitor detector 26 is shown in a position where it detects scattered leaking light at the entrance to the fiber, but can alternatively and preferably be placed where it detects scattered light from the cavity, even behind the back mirror, as will be explained in connection with FIG. 6 below.

According to further preferred optional laser configurations, the TEC can be operative such that it heats the complete cavity in order to generate and control an optical phase shift by thermal change of the cavity length, instead of implementing a phase section inside the diode chip 31. Alternatively and preferably, a heater 37 can be used attached to the laser diode chip in order to generate optical phase shift, instead of implementing a phase section inside the diode chip.

As mentioned already in relation to the embodiment of FIG. 1, the etalon should preferably be placed at a small angle to the lasing beam to avoid, interference effects from reflections from the etalon faces. If the tilt angle is somewhat increased, the etalon can behave as a folding element, and the reflected beam from any of the etalon surfaces can be used to couple power to the output fiber and/or for power monitoring purposes.

Reference is now made to FIGS. 4A, 4B and 5, which are schematic illustrations of lasers, according to two further preferred embodiments of the present invention, having the etalon 12 in such an increased tilted configuration. The two embodiments differ in the method by which the output beam to the fiber is extracted from the cavity. The etalon can behave as a folding element, and the reflected beam from any of the etalon surfaces can be used to couple power to the output fiber and/or for power monitoring purposes.

In both of these embodiments, since the external cavity length is generally designed to be as short as possible, the cavity lens 16 is very close to the etalon 12. FIG. 4B shows the area around the tilted etalon 12 in enlarged scale, to illustrate how the tilt of the etalon causes the beam 45 transmitted there through to be slightly laterally displaced. The beam 41 is reflected from the GWS back to the etalon, and then some of the light goes through the etalon and some is further reflected back to the GWS, impinging on the GWS at a non-perpendicular angle because of the tilt of the etalon. However, it is not obstructed by the GWS filter, and passes straight through, since the filter is not in a resonance for that tilted beam. This occurs because a filter at resonance for a perpendicular incident beam, cannot be at the same time at resonance for a beam of the same wavelength that is not perpendicular to the filter surface.

In the preferred embodiment of FIG. 4A, the beam is output from the etalon side of the cavity, by disposing the fiber coupling section, comprising the preferably isolator 24, fiber input lens 28 and output fiber 27, behind the GWS 11. In this configuration, the diode front facet 36 then has a high reflection coating as end mirror. The power monitoring detector is preferably placed near the diode front facet at location 42 where it monitors the beam leakage through the facet end mirror. The beam splitter and collimating lens of the embodiment of FIG. 2 are not needed in this configuration. The additional detector 44 at the back side of the GWS is preferably used for fine-tuning the GWS filter resonant wavelength, by sampling the beam passing straight through the GWS.

In the preferred embodiment of FIG. 5, the beam is output from the laser diode front facet 36; by having a partially reflective output coupling mirror on the end facet, and by disposing the fiber coupling section, comprising preferably the collimating lens 23, preferably isolator 24, fiber input lens 28 and output fiber 27, beyond the laser diode front facet 36, as in the configuration of FIG. 2. However, unlike the embodiment of FIG. 2, the power monitoring is performed preferably by measuring the cavity power by means of a PIN diode 53 located behind the GWS, at an angle where it sees the deflected main beam 51 passed from the tilted etalon 12 through the GWS 11. Another detector 52 can be used in order to fine-tune the GWS filter resonant wavelength, as for the embodiment of FIG. 4.

Reference is now made to FIG. 6, which schematically illustrates another laser configuration, according to a further preferred embodiment of the present invention. According to this embodiment, the GWS filter element is used as a tuning filter and as a folding element within the cavity, but not as one of the cavity reflectors. The GWS filter can work as a tunable mirror for non-perpendicular incident beams as well. However, since a GWS filter is polarization dependent, the operating conditions must take into account during GWS filter design, whether the tilt is performed around the main axis of the GWS, i.e. around the grating direction, or perpendicular to it. In this embodiment, the full reflector 61 of the cavity is preferably a high reflectivity mirror, or a corner cube retroreflector or a cat's eye element. The corner cube retroreflector or cat's eye element embodiments have the advantage that since these elements reflect back the incident beam and do not require a precise angular alignment of the reflection element, the laser construction is simplified. Avoiding the precise tuning requirements of the back mirror makes assembly of the laser much simpler and makes the laser more robust to thermal variation and mechanical deformation or shift.

The cavity of the laser thus comprises an output coupling partial reflector on the diode front facet 36, and a full reflector 61 at the other end of the cavity, with the tuned GWS filter 11 operative as a tuned folding mirror within the cavity. The power monitor sensor 26 can be placed close to any region at the output side of the laser where it can view energy scattered out of the laser output beam. Alternative and preferred locations for this can be close to the output coupler on the diode end facet for viewing energy scattered out of the laser diode 14, which is the location shown in FIG. 6, or close to the collimating lens 23, or the isolator 24 or the fiber lens 28 or an edge of the fiber itself 27. The beam splitter used in the embodiment of FIG. 2 can be omitted. Another detector can be placed behind the GWS to monitor the beam passing through the filter in order to tune the center frequency of the GWS. The detector can be placed in location 62 to monitor the straight through beam, and/or in location 63 to monitor the beam after being returned from the mirror 61, and passing through the GWS. Power can alternatively be coupled out by placing the collimation lens 23 and the associated other coupling devices 24, 28 27 at location 62 or location 63.

Reference is now made to FIG. 7, which schematically illustrates another laser configuration, according to a further preferred embodiment of the present invention using the GWS as a cavity folding tuned mirror, similar to that shown in FIG. 6. However, FIG. 7 differs in that a corner cube retroreflector 70 is used instead of the full reflector 61 of FIG. 6, thus simplifying laser construction and improving laser stability as mentioned above. Alternatively and preferably, a cat's eye lens 71 with a mirror 72 positioned behind it can be used with similar advantages.

Reference is now made to FIG. 8, which schematically illustrates another laser configuration, according to a further preferred embodiment of the present invention, using the GWS as a cavity folding tuned mirror, but having reversed cavity geometry to that shown in FIGS. 6 and 7, with the diode front facet 36 of the laser 14 acting as the back mirror, with a power monitoring back-leak diode 82 behind it, and the output coupling being performed at the opposite end of the cavity, beyond the cavity folding position of the GWS. Additionally, according to this preferred embodiment, a cat's eye lens 71 is used in the output coupling arrangement. Alternatively and preferably, the fiber tip 81 can be used as the reflecting mirror. Use of a cat's eye lens enables the power to be coupled to the fiber in a more compact way, and with the advantages described above regarding ease of alignment. The tip of the fiber 81 is located at the focal length of the cat's eye lens 71 and preferably has a partially reflecting coating on it, and thus acts as the output coupler of the laser cavity. Part of the energy incident on it is reflected back into the cavity, and the other part is coupled out into the fiber.

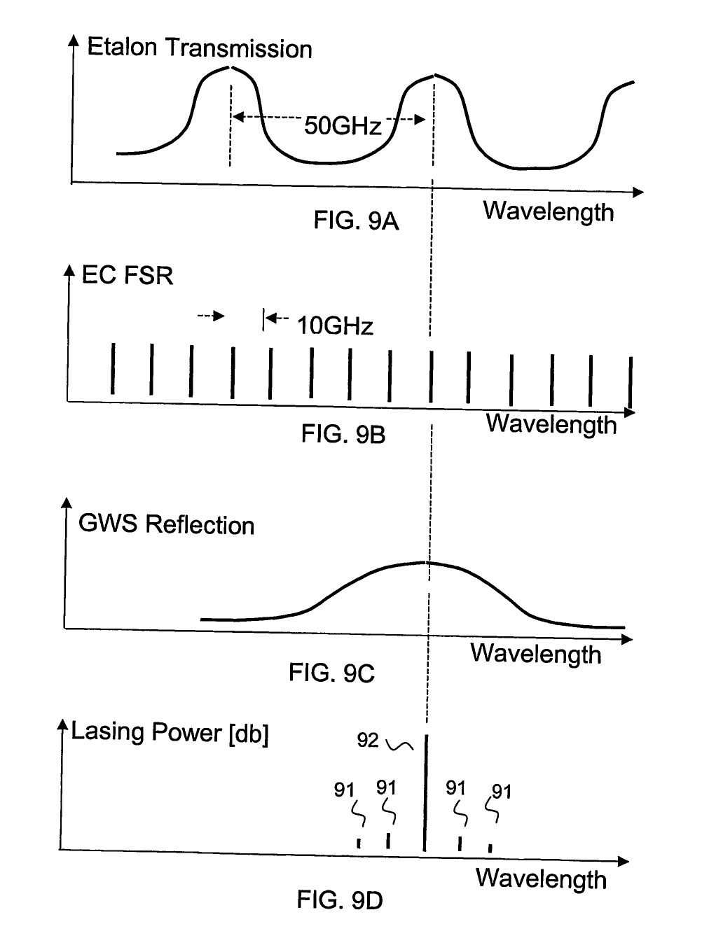

Reference is now made to FIGS. 9A to 9D, which illustrate graphically how the use of an etalon in an external cavity laser, together with a tunable filter of the GWS type, enables mode synchronization to be achieved in the laser. A laser for which the intra cavity etalon Free spectral Range (FRS) is an integer multiplicand of the external cavity FSR is called herein a “synchronized laser”. Use of a synchronized laser can be advantageous for simplifying the phase locking control system, and for reducing the phase locking timing and reducing the phase tuning range.

In FIGS. 9A-9D, separate spectral plots are respectively shown of the etalon transmission and FSR, the External Cavity (EC) FSR, the GWS reflection and the resulting output laser power spectrum. In the example illustrated in FIGS. 9A-9D, the integer multiplicand is 5, the etalon FSR being 50 GHz and the EC FSR being 10 GHz.

The advantage of the use of a synchronized laser is that the cavity phase remains essentially unchanged when the GWS is tuned to work at another ITU grid wavelength. Cavity phase is the summation of diode phase, etalon phase, GWS phase and phase shift due to the physical cavity length. Diode phase does not change much when tuning since a relative wide bandwidth diode is used, and furthermore, use is made of a diode having a low Line Enhancement Factor, and hence a low phase shift to gain ratio. Furthermore, the etalon transmission at its peaks, which is the most dominant factor in determining the laser gain, is approximately unchanged for all ITU grid wavelengths. As a result, cavity losses remain reasonably constant, and hence also the diode phase shift resulting from the cavity gain. The GWS is tuned to be at resonance for any ITU grid wavelength selected, such that the GWS phase shift is constant for all ITU wavelengths. The etalon phase shift too is constant for all ITU grid wavelengths, since the laser is locked to work at the etalon peaks.

The overall result of the above effects is thus that there is little, if any, laser phase change with change of wavelength.

There are a number of advantages of a synchronized laser over a non-synchronized laser:

(i) There is no need to introduce a large phase change in the cavity, whenever the GWS is tuned to select an ITU wavelength other than the one that was previously selected.

(ii) The cavity phase shift can be implemented by use of a simpler or less expensive phase element, than by the addition of an otherwise unneeded phase section inside the diode laser chip.

For synchronized laser as well for non-synchronized ones, a cavity phase change can be achieved by a number of alternative methods, such as by having a phase section in the diode laser chip, by introducing a liquid crystal phase retarder element inside the cavity to change the effective optical cavity length, by moving one of the cavity reflectors with a Piezoelectric element to generate a real cavity length change, by heating the diode chip or by heating the cavity optical bench, etc. Some of these methods are slow, especially those based on thermal effects. Reduction of the required phase change required in order to switch between different selected ITU grid, is most important since it decreases the switching time between different ITU grid wavelengths.

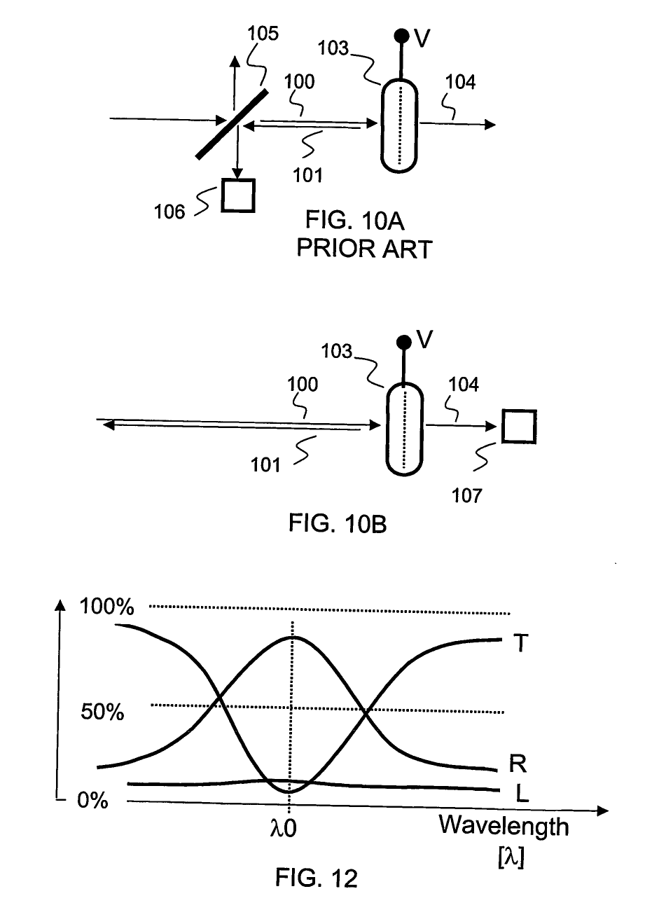

Reference is now made to FIGS. 10A and 10B, which illustrate schematically an important difference between prior art arrangements for aligning GWS type of tunable filters or mirrors, and the methods and systems of the present invention. When using a tuned filter or mirror such as a GWS, the control voltage has to be adjusted so that the GWS will reflect back a beam with a desired wavelength. Maximum incident beam power is reflected back from the GWS filter/mirror, when the GWS resonant wavelength peak exactly matches the incident beam wavelength. In order to get maximum beam power reflected from the GWS, the GWS control voltage needs to be fine-tuned. The GWS resonant wavelength peak is mainly a function of the applied control voltage, but it is also affected by other parameters like temperature, other environmental conditions, GWS aging, and others. In order to provide accurate tuning despite these side effects, and to obtain maximum power reflection, a closed-loop should be used to measure the instant reflected power and to fine-tune the GWS control voltage accordingly. It is understood however, that even if the GWS itself undergoes long-term aging, methods are known of incorporating a fixed and stable reference filter within the lasing system, in order to provide a known wavelength reference point against which to correct for the GWS aging by adjusting the control input accordingly.

When aligning such a tunable mirror or filter according to prior art methods of operation, the control voltage applied to the GWS tunable filter/mirror is adjusted to achieve maximum power reflected from the beam incident on the GWS. Maximum power ensures that the center of the GWS resonant wavelength peak is aligned with the incident beam wavelength. When a GWS element is used as a tuning element in a laser, accurate GWS tuning improves the Side Mode Suppression Ratio (SMSR), and increases laser power and laser mode stability.

Reference is now made to FIG. 10A, which is a schematic illustration of such a prior art arrangement for aligning a GWS type of tunable filter or mirror or any tunable filter in general. The incident beam 100 impinges on the tunable filter or mirror 103, the major part of the beam is reflected 101, and a small part 104 passes through the GWS and is transmitted onwards. The reflected main beam 101 is sampled, typically by means of a beam splitter 105, and the sampled power measured by a detector 106 whose output is used to provide feedback to adjust the voltage V applied to tune the GWS.

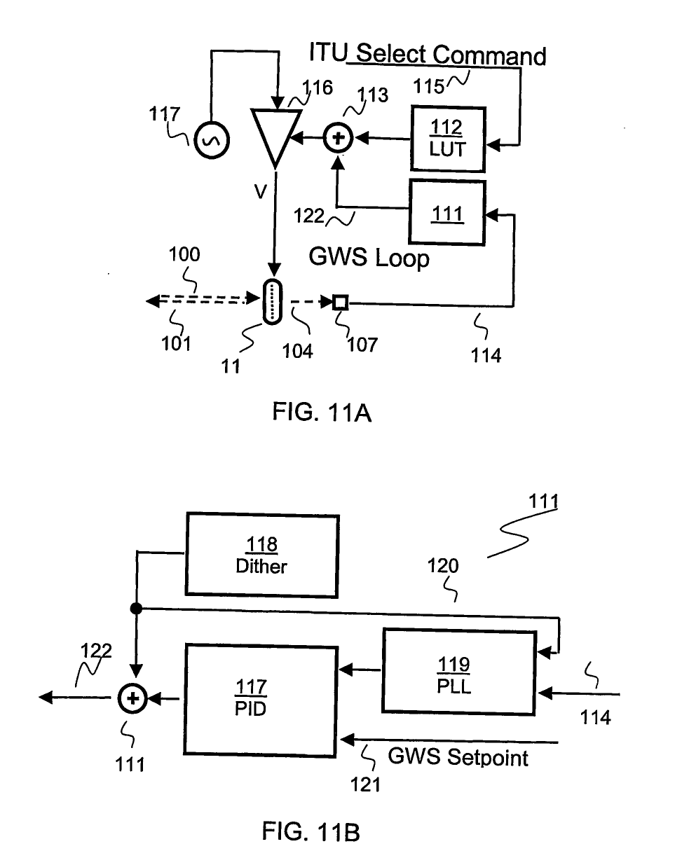

Reference is now made to FIG. 10B, which is a schematic illustration of a novel arrangement for aligning a GWS type of tunable filter or mirror 103, according to a further preferred embodiment of the present invention. According to this method, the power transmitted through the GWS is measured, and the GWS control voltage is fine adjusted to maintain the transmitted power at its minimum level. In FIG. 11A, a preferred feedback control circuit for effecting this method of measurement and control is shown. The beam 104 transmitted through the GWS 103 is measured on the monitor detector 107, whose output 114 is input to a control circuit 111 for fine tuning the GWS for minimum transmitted power. The control signal from this control circuit is directed to an adder 113 where it is impressed on a coarse tuning voltage obtained from a look-up-table (LUT) 112 according to the nominal wavelength to which the GWS is to be adjusted The desired tuned wavelength is input as a wavelength select command 115. The combined GWS control signal is then input to a gain control amplifier 116, which amplifies the alternating voltage wave source 117 for driving the GWS 103 at the alternating voltage amplitude level required to provide the desired reflection of the GWS. The control loop is set to tune the GWS to the point at which minimum transmitted light passes through the GWS.

FIG. 11B now illustrates schematically a preferred method of implementing the control circuit 111 of FIG. 11A. The signal 114 from the monitor detector 107 is input into a Phase Lock Loop (PLL) circuit 119, where it is synchronously amplified with the dither frequency 118. The amplified PLL output is input to a PID (Proportional Integral Differential) control circuit, where it is compared to the set point command 121, which is input as the minimum predetermined level at which the control loop is considered to be optimally closed. The dither frequency signal 118 is added to the output correction GWS signal which itself is impressed in the adder 113 of FIG. 11A, onto the drive setting obtained from a Look-Up-Table (LUT) 112. Such a dither frequency must be impressed on the loop signal for the PLL to function, as explained hereinbelow.

This method of searching for a minimum transmission through the GWS has a number of advantages over the prior art methods that measure the reflected beam. Firstly, the location of the power detector at the backside of the GWS filter/mirror is a position that does not interfere with the incident beam or the reflected beam. Secondly, the measurement sensitivity of the measured power change relative to the total power measurement, as a result of a given resonant wavelength peak shift in the GWS, is much higher for a transmission measurement than for a reflection measurement. This is apparent by reference to FIG. 12, which is a graph showing the relationship between the reflected power R, and the transmitted power T, around the GWS resonant wavelength. The higher sensitivity transmission measurement is due to the fact that the transmitted power at resonance is several times lower than the reflected power at the same wavelength, such that the percentage change in its level is several times more pronounced.

To illustrate this effect, when, for example, a shift in the GWS wavelength causes a change in reflection from say 94% to 96%, which would be measured as a 2.1% reflected power change, the transmitted power, assuming an imaginary condition of no losses L, would change from 6% to 4%, which would be measured as a 33% change.

For applications in which the GWS is used as one of the two mirrors of a laser cavity, measurement sensitivity of the reflected beam is low, since power in the laser cavity is a logarithmic function of the mirror reflections, which is not a strong dependence on mirror reflectivity. On the other hand, the power passing through the GWS filter/mirror is highly dependent on the resonant wavelength of the GWS filter/mirror. Therefore measurement of the transmitted beam power in laser applications is much more advantageous than the measurement of the reflected beam.

In laser applications, a shift in the GWS resonant peak causes the laser wavelength to shift due to the optical phase shift that the GWS imposes on the cavity optical phase. This affect does not change the effectiveness of the above-described method.

In implementing the above-described method, there are two ways to lock the closed loop of the control system onto the point of minimum power transmission through the GWS:

(a) Implement a control loop that utilizes a measurement of the power transmitted through the GWS, and adjust the GWS control voltage in order to reduce the measured power. This iterative adjustment can preferably be performed in the control system CPU, by making small signal adjustments in both directions around the operating point, and following changes of the power after the laser has reestablished phase stability. This method is therefore slow.

(b) Implement a Phase Lock Loop (PLL) circuit, as shown in the preferred implementation of FIG. 11B above, that automatically locks onto the minimum power transmitted through the GWS. In order for the PLL to operate properly, an AC signal, also known as the “pilot tone” or dither has to be impressed on the loop signal.

There are several ways to get such an AC dither signal into the loop:

(i) Use the AC signal that is already involved in the GWS control voltage. The GWS control voltage is basically an AC voltage applied to a liquid crystal layer within the GWS element. This causes the resonant peak to oscillate at twice of the AC frequency. This approach cannot generally be used in a laser due to the power change effect caused by the GWS phase dither in the cavity phase. Cavity phase locking should be much faster than the phase disturbance made by the GWS to the cavity phase, in order to maintain constant laser power, unaffected by the phase shift introduced. However, for uses other than lasing, the dither signal generated by the GWS itself can be used to lock the filter wavelength exactly on the center wavelength of the wave being handled by the filter.

(ii) Modulate the GWS control voltage with an additional AC voltage at a frequency slow enough to enable the laser system to remain phase locked during the dither slope duration. i.e. during the ramping time of the phase locking loop. That keeps the cavity power constant, unaffected by the GWS phase dither, leaving only the GWS transmission to play the dominant effect.

In the above-described methods of fine tuning of the GWS filter according to the laser wavelength, the tuning information can be used in order to update the LUT for any long term changes which may have taken place due to aging.

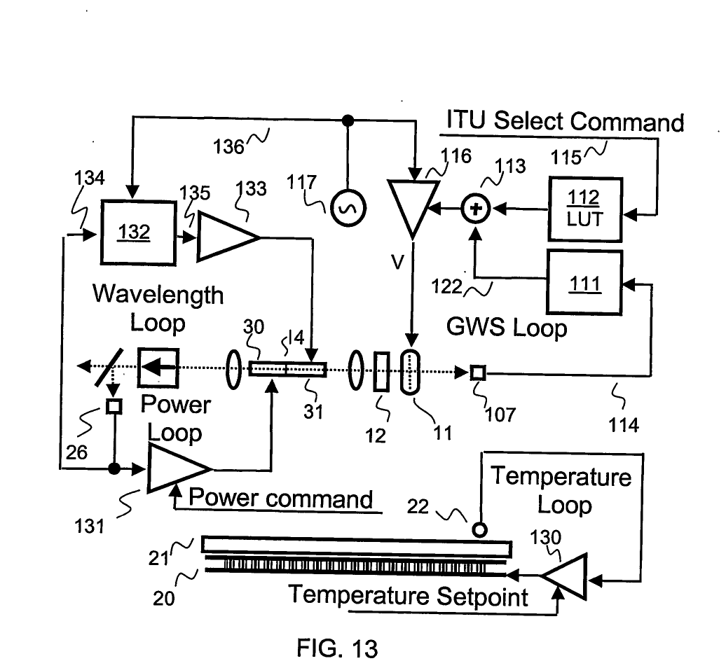

Reference is now made to FIG. 13, which is a schematic block diagram of the control algorithm and control hardware for a tunable laser having an intra-cavity etalon and GWS filter control, constructed and operative according to another preferred embodiment of the present invention. The control loop and algorithm differ from those used in the prior art in that the laser is controlled by several different controls loops, each having one variable control only, which are very simple to design, are very robust, and are largely independent.

The laser control system preferably comprises up to four separate and largely independent control loops, working in parallel:

1. Temperature stabilization

2. Power stabilization

3. Wavelength (Phase) stabilization

4. Channel selection

The control loop can be implemented on a microcomputer chip, or on a Digital Signal Processor (DSP) or using analog hardware such as integrated amplifiers act's, or using digital hardware such as gate arrays or PAL's, or similar.

The control concept enables wavelength and power locking over a wide range of wavelengths, such as the whole of the C-band for example, and a wide range of output power. The control system provides the following advantages:

(i) There is no need for an external wavelength locker.

(ii) There is no need for an external Variable Optical Attenuator (VOA).

(iii) The concept implements a closed loop approach to reduce dependence of the wave-locking accuracy on temperature, aging, electrical and mechanical setting accuracy.

(iv) The control system prevents jitter side effects in the tunable filter from reducing the stability of the laser.

The operation of each of the four independent preferred control loops is now explained in detail, by reference to FIG. 13, which shows a preferred embodiment of the control operating on the tuned laser embodiment of FIG. 2. It is to be understood, though, that any of the relevant laser embodiments shown in this application could equally have been used to illustrate the application of the control concepts of the present invention.

1. Temperature Stabilization Control Loop

This control loop maintains the laser temperature, or more specifically, the etalon temperature, at the precalibrated value. In the laser shown in FIG. 13, the intra-cavity etalon 12 serves as the wavelength locker. The etalon is mechanically and thermally attached to the optical bench 21, which is mounted on a TEC plate 22, whose temperature is measured by means of a thermal sensor 22, such as a thermistor. During manufacture and set-up of the laser, the optical bench temperature should be fine adjusted to a working temperature that provides a good match between the ITU grid wavelengths and the etalon peaks. This optical bench calibrated temperature should be maintained for the entire working life of the product by means of the temperature stabilization control. This is performed by means of a PID (Proportional-Integral-Differential) control algorithm, preferably operating within the temperature control circuit 130, to maintain the etalon temperature at the predetermined temperature set-point input.

2. Power Stabilization Control Loop

The control loop maintains the output power at the requested power level, by means of an input Power-command. In the laser shown in FIG. 13, the output laser power level is monitored by the PIN diode 26, whose output is fed to the power control circuit 131, which compares the output power with the desired power command level, and using a PID control algorithm, sends the appropriate control signal to the diode laser gain section 30 to maintain the requested power level.

Fast changes of the power-command change the diode current, which in return affects diode phase and therefore also affects the wavelength control loop. Slow ramping of the power command enables the wavelength locking mechanism to stay locked.

3. Wavelength Locking Control Loop

This control loop maintains the laser wavelength at the selected wavelength in the ITU grid, by monitoring the output power and fine adjustment of the cavity phase. When the output is at its peak value, this indicates that the laser wavelength is situated exactly on the peak of the etalon, and is thus matched to the selected ITU grid wavelength. The loop keeps the output power at maximum, and hence the laser wavelength continually matched to the etalon peak, by control of the laser cavity phase. In the preferred embodiment shown in FIG. 13, the output power is determined by the PIN diode 26, whose output is fed to a peak detecting circuit 132, which provides the input signal to the wavelength locking control circuit 133. A PID control algorithm operating therein controls the current to the phase section 31 of the laser diode 14. The peak detection circuit is required in order to detect maximum power. As long as the cavity phase is set to provide maximum output power, and the tunable mirror peak wavelength is close to the selected wavelength of the ITU grid, then the laser will operate in single mode at the desired wavelength, and have a high SMSR, as was illustrated in the graphs of FIG. 9. The dither signal 117 is also added into the wavelength phase locking loop in order to ensure correct operation of the PLL therein.

Alternatively and preferably, instead of using a laser diode with an on-chip phase section 31, with its additional expense, it is possible to control the laser phase by adjusting the entire cavity length by temperature control of the optical bench 21, or by thermally heating the diode chip alone, as described hereinabove in relation to the embodiment of FIG. 3. This approach may require that the etalon 12 should be thermally insulated from the optical bench and attached to its own controlled heater, since the etalon temperature may be separately controlled in order to maintain a good match between the etalon peaks and the ITU grid.

4. Channel Selection Control Loop

During manufacture of the laser, a LUT is generated relating the tunable mirror control voltage to the resonant wavelength of the tunable mirror. During use of the laser, for instance in an optical communication system, approximate adjustment of the tunable mirror voltage is performed in open loop using this LUT, to tune the mirror approximately to the desired wavelength from the ITU grid. The LUT converts the channel command into the appropriate tunable mirror control voltage, such that the mirror wavelength peak is close to the desired ITU wavelength. If the tunable filter temperature was absolutely stable and aging effect were absent, this adjustment would be sufficient to provide adequate accuracy to the wavelength selection. This is generally true for coarse ITU grids such as 200 GHz, 100 GHz and possibly even 50 Gz.

However, in order to provide closer and more accurate wavelength control, such as is needed with 25 GHz ITU grid operation, optional fine adjustment of the tunable mirror voltage is provided by the channel selection control loop, in order to overcome thermal changes in tunable mirror temperature and/or drift of the tunable mirror control voltage due to the electronic control circuit, or wavelength changes due to GWS aging since the LUT was generated.

In the laser embodiment shown in FIG. 13, the tunable mirror 11 is mechanically and thermally attached to the optical bench 21, which itself is thermally attached to the TEC plate 20 for controlling the laser temperature. The lasing power is sensed at the backside of the tunable mirror 11, preferably using a PIN diode 107, and the output is input to the Channel selection control circuit 111. A PID control algorithm operates within the channel selection control circuit, to adjust the mirror tuning current in closed loop to obtain minimum power at the backside of the mirror. The output control signal is added 113 onto the LUT mirror control voltage 112 corresponding to the desired channel wavelength 115, thereby fine-tuning the drive voltage for the tuning mirror from the predetermined LUT value to an optimized value which positions the laser wavelength exactly on the ITU selected wavelength. Such fine adjustment of the tunable mirror voltage, improves the laser stability and the laser SMSR. A dither frequency signal 118 is also added into the loop. Fuller details of the operation of the channel selection control are given above in relation to the embodiments of FIGS. 11A and 11B.

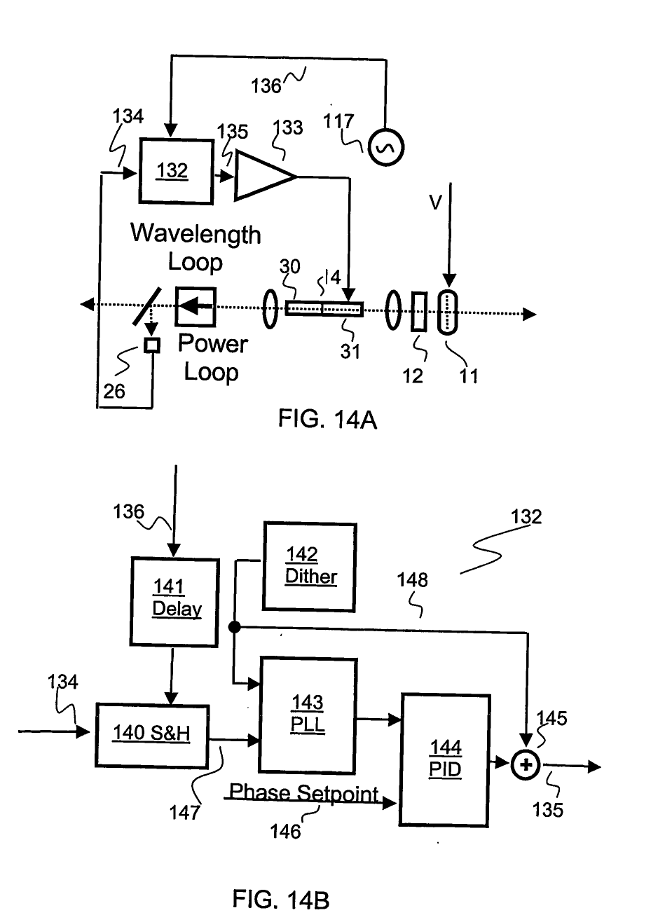

Reference is now made to FIG. 14B, which is a block diagram of the wavelength locking circuit 132 of FIGS. 13 and 14A. The aim of the circuit is to lock the laser wavelength precisely on the ITU selected wavelength. The GWS control circuit selects the requested ITU wavelength separately, by tuning the GWS to approximately the ITU wavelength selected, but the precision and the durability of the wavelength actually output from the laser arises from this wavelength locking circuit.

The locking concept is based on the maintenance of the laser power at its maximum value. Since the etalon is already preset in synchronization with the ITU grid, maximum output power is indeed obtained at the etalon peaks.

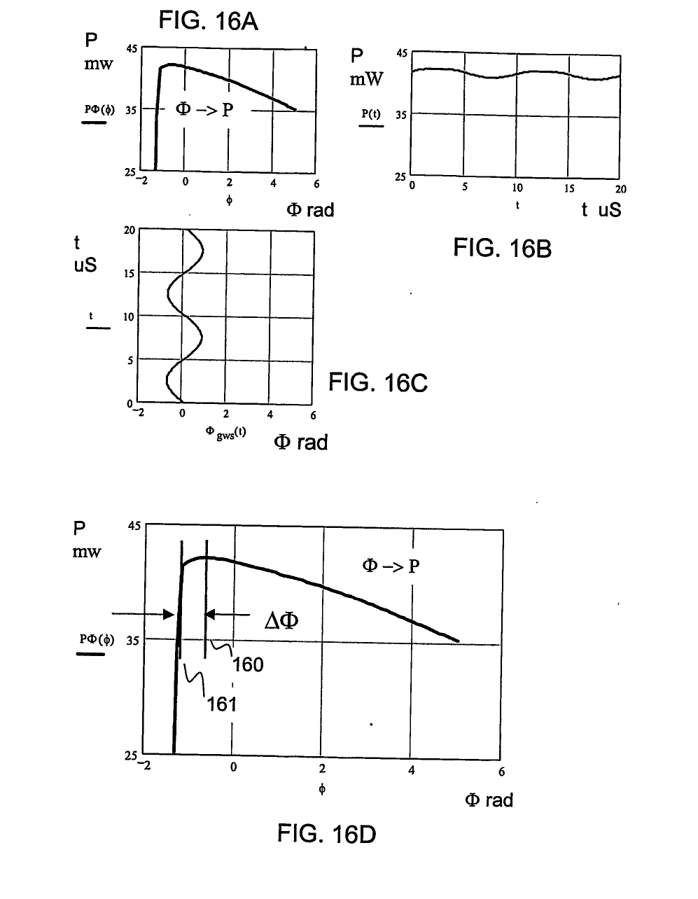

Maintenance of lasing at the etalon peaks has an important side-benefit, in that it avoids approaching the region of mode-hopping. As will be observed in FIG. 16A below, there is a phase margin between the cavity phase of the laser at the etalon peak wavelength and the phase of the laser at the moment of mode-hop. By keeping the laser operating at the etalon wavelength peak, it is ensured that the laser is operating at a stable working point with a good margin. The phase margin is a function of the ratio between the etalon bandwidth and the cavity FSR. It is also highly dependent on the diode Line Enhancement Factor.

The preferred method of locking onto the point of maximum power is a good method since it is not dependent of the laser parameters, and especially not dependent on diode chip aging and thermal shifts. However, alternatively and preferably, locking can be performed onto a predetermined power slope, whereby a working point is sought for which the power changes by a predefined value for a given phase shift. In such an embodiment, instead of looking for a maximum value, for which the power slope is zero, a slope other than zero can be sought.

In the circuit of FIG. 14B, the power sensed signal 134 is input into a Sample and Hold circuit 140 which is operative to grab the monitor signal at the extreme of the phase change resulting from the synchronous signal 136 injected thereon. This could be the phase at which the laser is closest to the mode hop phase, or any other phase that the laser system designer prefers to clamp the phase to. The application of the phase dither signal 142 enables detection and locking onto maximum power, or onto a predefined slope, using a Phase Locking Loop (PLL) 143, in a similar way to that described with respect to the GWS loop described in the embodiment of FIG. 11B. Use of a PLL can be avoided and the phase nevertheless locked, by forcing small phase changes in the cavity and analyzing the power reading as a results to those changes. Addition of a Sample and Hold circuit prevents synchronous phase noise from causing a mode-hope, from affecting the SMSR, and thus highly modulating the power and wavelength. There is a need to synchronize onto the peak of the phase noise, as will be explained further hereinbelow.

The GWS self-synchronous noise can also be utilized as the source of the cavity phase dither. The GWS wavelength can be dithered in order to generate a phase dither in the cavity, which can then be used for wavelength locking.

The tunable filter might suffer from synchronous noise, such that its tuned wavelength oscillates around the set tuned wavelength at a known frequency. For example, a GWS filter has an applied alternate voltage to operate the liquid crystal element. As a result the filter wavelength oscillates around the tuned wavelength, having synchronous noise frequencies that are related to the AC tuning voltage frequency.

There is also a phase synchronous noise associated with the wavelength synchronous noise of the filter. Therefore wavelength synchronous noise also generates phase synchronous noise in the laser cavity. The phase synchronous noise of the filter is dominant laser noise and if excessive, may force the laser into a mode-hopping state.

A GWS tunable filter, other tunable filters and other laser system that are required to be wavelength locked, may suffer from synchronous noise. Synchronized noise means that the wavelength resonance is oscillating at a predefined frequency, or at a frequency that can be detected and synchronized to. Synchronous noise is a side effect that reduces the laser performance. The synchronous noise wave shape, frequency and amplitude not design parameters, but can arise from some external interference or operating parameters. The GWS filter has a Liquid Crystal (LC) inside requires an AC voltage for its operation. The GWS AC voltage may cause a synchronous noise, with the result that the resonance wavelength oscillates slightly around the tuned wavelength at a frequency that is twice than the AC voltage frequency, and also imposes a phase synchronous noise on the laser cavity.

The proposed wavelength-locking algorithm can work even in the presence of such synchronized noise. Synchronized noise does not affect the validity of the above-described locking operations. It is important to define a robust and high power operating point of the laser in spite of the presence of synchronous noise.

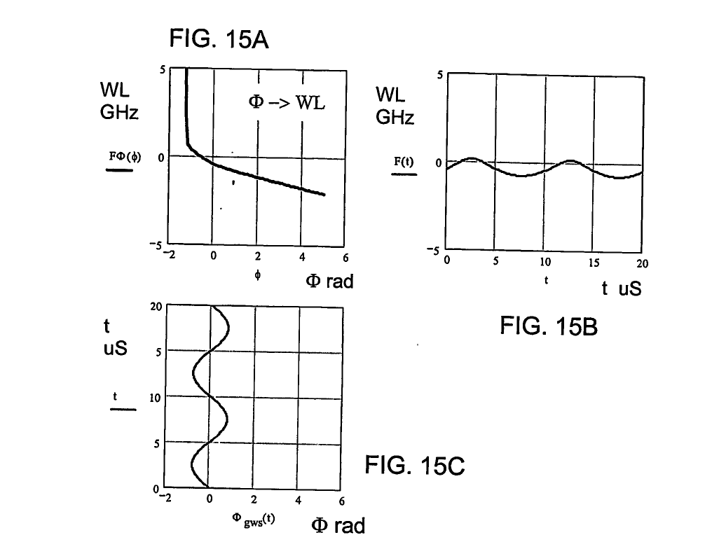

Reference is now made to FIGS. 15A to 15C, which are plots showing the wavelength response of the laser to cavity phase oscillation, such as would be generated by synchronous noise. FIGS. 15A-15C are plotted for a representative case of a tunable laser with an intra cavity etalon, for which the etalon bandwidth is not wide compared to the laser FSR FIG. 15A is a plot of the lasing frequency shift F(φ) in GHz, which can easily be translated into wavelength in nm, as a function of the cavity phase shift. The lasing frequency shift is the difference between the current lasing frequency and the etalon peak frequency, and is an indication of the deviation of the lasing frequency from its intended value at the etalon peak. Cavity phase shift is the difference between current cavity phase and some preset value. The preset value is of no importance since it is the phase shift that is of importance, rather than the absolute value.

As is observed from FIG. 15A, a shift of approximately −1.3 radians from zero will cause the laser to enter a mode-hop situation, and the laser frequency will undergo a steep change as the laser jumps to other mode line. Since at a mode hop, the phase changes by up to 2π, the actual lasing frequency shift F(φ) will jump to a position where the phase shift is given by 2π−1.3=˜5 radians, depending on the GWS bandwidth ratio to the EC FSR, and on the diode Line Enhancement factor. At the point φ=5 radians, from FIG. 15A it is observed that the lasing frequency is shifted −2 GHz from the etalon peak frequency.

FIG. 15C is plot showing the time varying effect of phase synchronous noise in the cavity at a frequency of 100 kHz (10 μsec period). The phase amplitude is seen to be +/−0.8 radians.

FIG. 15B shows the laser response to such phase synchronous noise, as a function of time.

FIGS. 16A to 16C are plots, similar to those of FIGS. 15A to 15C, but showing the effect of the cavity phase shift on the lasing power.

Reference is now made to FIG. 16D, which is an enlarged view of the graph of FIG. 16A to illustrate the optimum operating region of the laser. There is a range of operation from the point of maximum lasing power 160, to a point 161 just before the laser operation reaches the mode-hop condition, which is called the multi-mode line. This range, Δφ, is known as the phase margin.

As the phase synchronous noise increases, the output lasing frequency synchronous noise also increases to a point where the laser may operates in a multi-mode state, at which point the lasing frequency and the laser power change considerably and abruptly. This can also happen if the working point of the laser shifts to the left, that is to say, the center/average of the phase shift moves till the phase left side amplitude reaches the multi-mode line 161. It is important to operate the laser in a configuration that will avoid this mode-hopping region.

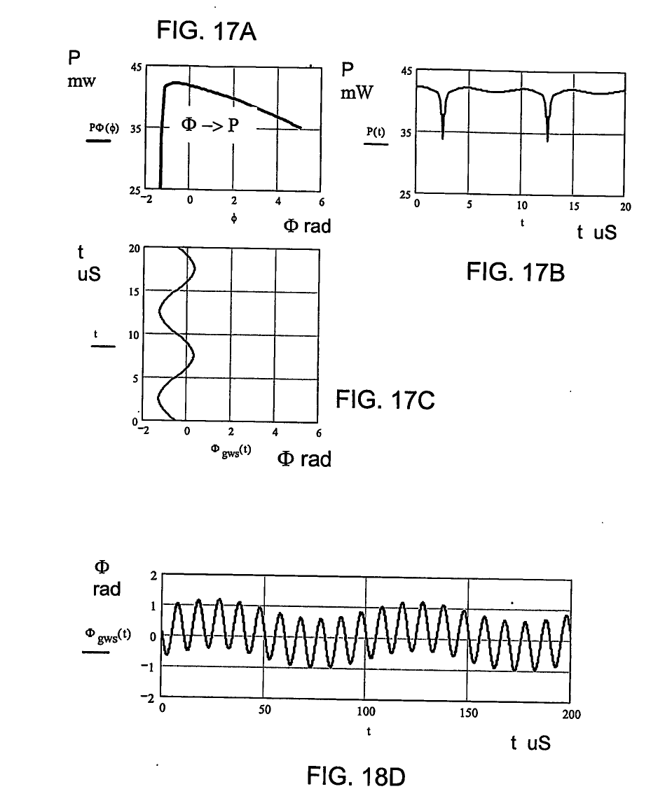

FIGS. 17A to 17C are plots, similar to those of FIGS. 16A to 16C, but showing the effect of the cavity phase working point shifting to the left compared to the plot of FIG. 15C and the lasing power reaches the mode hopping point of operation. The problem arising from the behavior shown in FIGS. 17A to 17C can be avoided if a method is found of avoiding the entry of the furthermost left phase point from entering the mode-hop line 161.

According to a further preferred embodiment of the present invention, this can be achieved by dynamically adjusting the laser working phase point such that the lower phase edge of the cavity synchronous noise does not move beyond the maximum power point 160 on the power versus phase working curves. Fine adjustment of the cavity phase or working point is performed such that the minimum phase excursion goes no further negative than the position of peak power 160 shown in FIG. 16D. The reduction in power output is slight, yet the laser operates in a stable configuration and without danger of mode hopping.

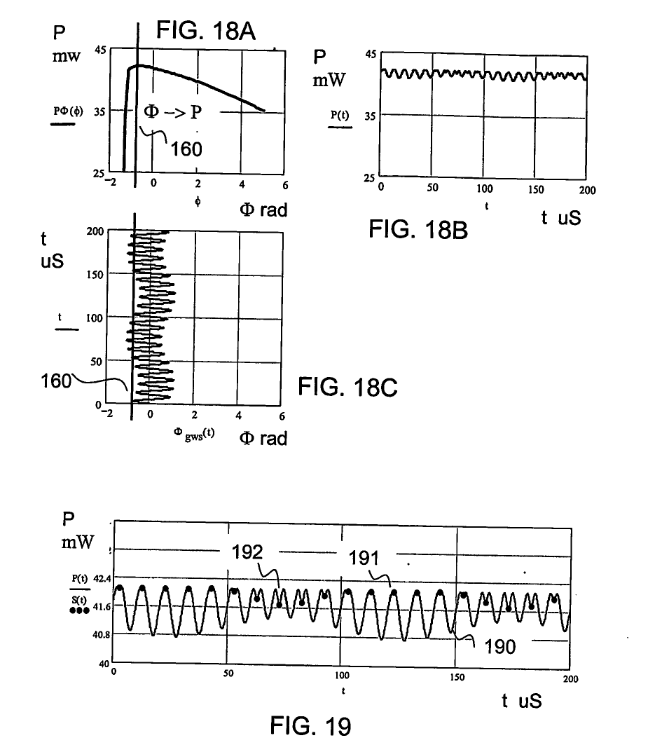

Reference is now made to FIGS. 18A to 18C, which are plots similar to the previous ones, but taken over a much longer time scale, so that it shows the lasing frequency shift and laser output power for a slowly modulated cavity phase, such as would be obtained from a dithered control circuit laser. As is observed in FIG. 18C, the result of the slow dither modulation is to cause the working point phase to move automatically by the control loop, to a point at which the phase minimum values oscillate around phase line 160 at the same slow modulation frequency as the dither frequency. The resulting laser output is shown in FIG. 18B, where it is observed that under the effect of the dither, the residual amplitude modulation changes in level synchronously with the dither frequency. In the example shown in FIGS. 18A to 18C, the phase synchronous noise is +/−0.8 radians at a frequency of 100 kHz, and is in the form of a sine wave. In all of the above plots illustrating synchronous phase effects, the phase synchronous noise amplitude is shown at an exaggerated level for the sake of graphical clarity, and in real-life applications, the true synchronous noise level of GWS devices, for instance, is substantially lower.

The phase dither shown in the examples of FIGS. 18A to 18C is +/−0.3 radians at a frequency of 10 kHz, and having a sine wave form. Dither levels implemented in real-life product applications are generally much lower than this level. Reference is now made to FIG. 18D, which shows a longer term plot of the laser phase shift of FIG. 1*C, showing how the dither imposed on the laser control loop, impresses a slowly varying change onto the laser phase shift, at a related frequency to the dither frequency.

Reference is now made to FIG. 19, which is an enlarged up plot of FIG. 18B, to show the exact details of the changes in the laser output power arising from the sample-and-hold circuit of FIG. 14B. As is observed, the output power 190 varies periodically between 40.8 mW and 42.0 mW.

The round points in FIG. 19, such as 191 and 192 are the sampled power points obtained by the Sample & Hold 140 of FIG. 141. Those sampled data are the output laser power whenever the synchronous phase noise is in its minimum values. Feeding those points to the PLL 143 of FIG. 14B enables the control loop to lock the phase working point at a value that is plotted in FIG. 18C. Sampling the power at some other points other than at the minimum phase noise can also be done, and will move the laser working point to the left. For the simulation shown in FIG. 18C that would mean going into the multi mode situation.

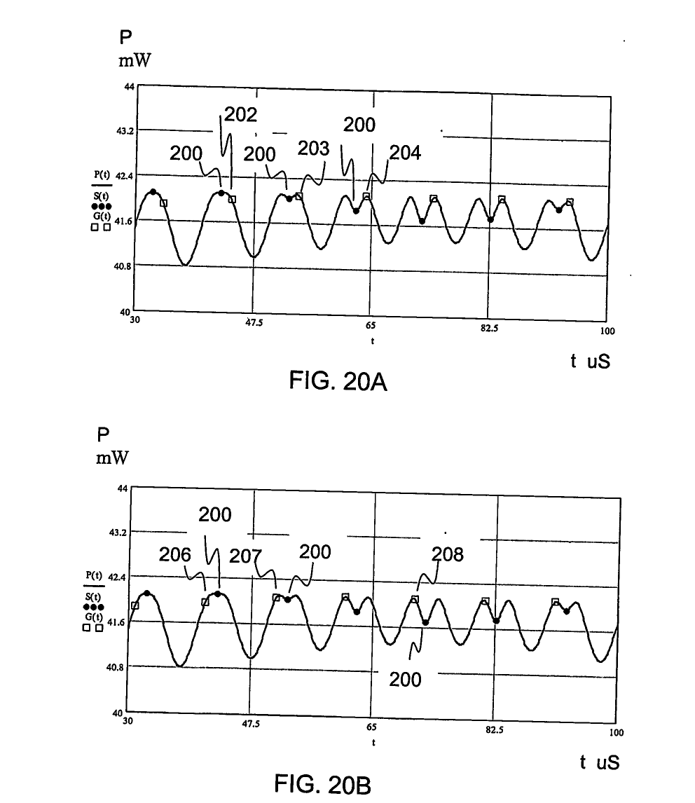

Reference is made now to FIGS. 20A and 20B, which are enlarged plots of FIG. 19B. The minimum phase noise sampling points are the set of round dots 200. Additional sampling of the output power at times shifted in respect to the first sampling set is shown by a set of square dots. According to a further preferred embodiment of the present invention, the wavelength loop can be locked without injecting a slow phase dither into the laser system in addition to its fast phase noise. The phase noise that already exists in the laser, whether it is injected intentionally as a dither, or was imposed on the system, is sufficient to control the wavelength loop.

The slow power variation of FIGS. 20A and 20B can be considered as a phase drift. Three types of additional sampled points are shown in FIG. 20A:

Point 203 has the same amplitude as point 200, so there is no need for a working point change.

Point 202 is lower than point 200, so there is need for a working point change in one direction.

Point 204 is higher than point 200, so there is need for a working point change in the other direction.

Referring now to FIG. 20B, a similar situation applies to a second sampled set having a different time shift with respect to the first set. These points are shown as 207, 206 and 208.

Reference is now made back to previously described FIGS. 14A and 14B, which show a circuit, constructed and operative according to a further preferred embodiment of the present invention, and capable of maintaining such a working point A detector 26 preferably located near by the output fiber samples the output power of the laser. According to a first preferred embodiment, a sample-and-hold circuit, synchronized with the synchronous noise frequency, samples the output of the power sensor once every cycle, at a predetermined point for which the phase synchronous noise is expected to have its minimum value in radians.

In the embodiment shown in FIG. 16C, the phase synchronous noise arises from the GWS tunable filter. The synchronous noise phase appearing on the lasing output on the monitor diode has a fixed delay compared to the sine wave AC control voltage applied to the GWS element. The variable delay element 141 shown in FIG. 14B enables adjustment of the sampling point, such that it falls exactly at the minimum phase synchronous noise of the filter. Once the delay has been initially set, that delay remains applicable for the entire life of the laser.

In cases where the phase synchronous noise in the cavity is due to some cause other then the GWS itself, the delayed input should come from the noise source circuit or from a noise synchronized detector. For example, a PLL connected to the power sensor output could be synchronized onto the noise frequency detected in the sensor output, and could send a trigger pulse after passage through the delay circuit, to the S&H gate input.

According to an alternative and preferred embodiment of the laser stabilization circuit, instead of using an analog sample-and-hold circuit, a digital sample-and-hold implementation can be performed using digital hardware or a DSP chip.

The sampled output power signal is now preferably fed into a Phase Lock Loop (PLL) circuit. This PLL circuit enables the cavity phase to be locked onto the sampled power signal. The PLL output is utilized to tune the cavity working point phase, preferably by applying a suitable control signal to the phase element of the cavity, such as by controlling the phase section current in the case of a diode laser with a phase section.

However, in order for the PLL to function, a dither signal has to be applied to the phase element, as described frequently hereinabove. The dither signal is preferably a small sinusoidal signal, of low amplitude and low frequency compared to the synchronous noise frequency. A typical example for use in a laser with a GWS tuning element, according to the present invention, would be for application of a dither at a frequency of 10 kHz and phase amplitude of +/−0.3 radians.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

I claim:

1. An optical lasing device, comprising:
a lasing medium disposed in a lasing cavity having an optical axis;
at least one end mirror disposed in said lasing cavity;
an etalon disposed within said lasing cavity; and
an electrically tuned filter device,
wherein said electrical tuning is achieved by electro-optical change of the optical characteristics of at least one of the materials of said filter device.

2. An optical lasing device according to claim 1, and wherein said filter device is a grating waveguide structure device.

3. An optical lasing device according to either of claims 1 and 2 and wherein said electrically tuned filter device is disposed with its plane essentially perpendicular to said optical axis.

4. An optical lasing device according to either of claims 1 and 2 and wherein said electrically tuned filter device is disposed with its plane at an angle of tilt from a plane perpendicular to said optical axis.

5. An optical lasing device according to either of claims 1 and 2 and also comprising a detector for determining the lasing power of said lasing device, and wherein said lasing device also comprises a controllable phase shift capability, and wherein said lasing device is locked to a maximum of said lasing power by adjusting the phase, thereby achieving locking to a wavelength predetermined by said etalon aligned to a required grid wavelength

6. An optical lasing device according to claim 5 and also comprising a closed loop system for adjusting said phase shift to achieve said maximum of said lasing power.

7. An optical lasing device according to claim 5 and wherein said adjusting said phase shift to achieve a maximum of said lasing power is also operative to wave lock said lasing device to a peak wavelength of said etalon.

8. An optical lasing device according to claim 5 and also comprising a closed loop system for adjusting said phase shift to achieve said maximum of said lasing power.

9. An optical lasing device according to claim 8 and wherein said closed loop system utilizes phase-sensitive-detection of the lasing power using an applied AC dither signal.

10. An optical lasing device according to claim 9 and wherein said grating waveguide structure is operated using an applied AC drive voltage, and wherein said dither is said applied AC drive voltage.

11. An optical lasing device according to claim 9 and wherein said dither is an external AC signal at a frequency other than that of said applied AC drive voltage, said external AC signal being injected into said optical lasing device by means of said controllable phase shift capability.

12. An optical lasing device according to claim 5 and wherein said controllable phase shift capability comprises a phase section of said lasing device.

13. An optical lasing device according to claim 5 and wherein said lasing device also comprises a thermal adjusting element, and wherein said controllable phase shift capability arises from thermal adjustment of said lasing cavity.

14. An optical lasing device according to claim 5 and wherein said lasing device also comprises a thermal adjusting element attached to said lasing medium, and wherein said controllable phase shift capability arises from thermal adjustment of said lasing medium

15. An optical lasing device according to claim 5 and wherein said controllable phase shift capability arises from fine adjustment of said grating waveguide structure.

16. An optical lasing device according to claim 5 and wherein said lasing device also comprises a phase retarder element, and wherein said controllable phase shift capability arises from adjustment of said phase retarder element

17. An optical lasing device according to claim 2, and wherein said grating waveguide structure device is operative as a tunable mirror to select the lasing channel.

18. An optical lasing device according to claim 2, and wherein said grating waveguide structure device is an intra-cavity tunable transmission device to select the lasing channel.

19. An optical lasing device according to claim 17, and wherein said tunable mirror is a cavity end mirror.

20. An optical lasing device according to claim 17, and wherein said tunable mirror is one of a full reflector and an output coupler.

21. An optical lasing device according to any of claims 1 to 20, and wherein said lasing device is any one of a solid state laser, a liquid laser and a gas laser.

22. An optical lasing device according to either of claims 1 and 2 and wherein said filter device has a resonance width broader than a passband of said etalon, such that the stability of said lasing device is determined by the stability of said etalon.

23. An optical lasing device according to claim 22 and wherein said stability is the wavelength stability.

24. An optical lasing device according to either of claims 1 and 2 and also comprising a detector for determining the lasing power of said lasing device, and wherein said lasing device also comprises a controllable phase shift capability, and wherein said lasing device is locked to a maximum of said lasing power by adjusting said phase, to achieve operation of said lasing device at a working point immune from mode hopping.

25. An optical lasing device according to claim 24 and wherein said adjusting said phase shift to achieve operation of said lasing device at a working point immune from mode hopping is also operative to wave lock said lasing device to a peak wavelength of said etalon.

26. An optical lasing device according to claim 24 and also comprising a closed loop system for adjusting said phase shift to achieve said maximum of said lasing power.

27. An optical lasing device according to claim 26 and wherein said closed loop system utilizes phase-sensitive-detection of a signal representing the lasing power using an applied AC dither signal.

28. An optical lasing device according to claim 26 and wherein said grating waveguide structure is operated using an applied AC drive voltage, and wherein said dither is said applied AC drive voltage.

29. An optical lasing device according to claim 26 and wherein said dither is an external AC signal at a frequency other than that of said applied AC drive voltage, said external AC signal being injected into said optical lasing device by means of said controllable phase shift capability.

30. An optical lasing device according to claim 28 and wherein said controllable phase shift capability comprises a phase section of said lasing device.

31. An optical lasing device according to claim 28 and wherein said lasing device also comprises a thermal adjusting element, and wherein said controllable phase shift capability arises from thermal adjustment of said lasing cavity.

32. An optical lasing device according to claim 28 and wherein said lasing device also comprises a thermal adjusting element attached to said lasing medium, and wherein said controllable phase shift capability arises from thermal adjustment of said lasing medium

33. An optical lasing device according to claim 28 and wherein said controllable phase shift capability arises from fine adjustment of said grating waveguide structure.

34. An optical lasing device according to claim 28 and wherein said lasing device also comprises a phase retarder element, and wherein said controllable phase shift capability arises from adjustment of said phase retarder element

35. An optical lasing device according to claim 27 and wherein said closed loop includes a sample and hold capability which samples said lasing power at time points synchronized with said dither signal, said dither signal arising from said grating waveguide structure applied AC drive voltage, said time points being selected at the closest phase distance from the regions of mode hopping, to prevent said dither from inducing mode hopping in said lasing system.

36. An optical lasing device according to claim 25 and wherein said closed loop system utilizes the detection of the direction of changes in said lasing power resulting from small applied perturbations to said tuning input.

37. An optical lasing device according to claim 2, and wherein said etalon, disposed within said lasing cavity has its plane at an angle of tilt from a plane perpendicular to said optical axis, and wherein said grating waveguide structure device is such that a beam having a wavelength of said lasing device, which is reflected from said grating waveguide structure device when incident thereon at normal incidence, is transmitted therethrough when incident thereon at an angle of tilt other than normal incidence.

38. An optical lasing device according to claim 37 and wherein a beam having said wavelength of said lasing device and reflected from a face of said etalon is extracted from said cavity through said grating waveguide structure.

39. An optical lasing device according to claim 37 and wherein a beam having said wavelength of said lasing device and reflected from a face of said etalon is monitored through said grating waveguide structure.

40. A method of tuning a grating waveguide structure mirror, said mirror transmitting a part of an incident beam impinging thereon, comprising the steps of:
impinging an incident beam on said mirror;
performing a measurement of said part of said incident beam transmitted through said mirror; and
utilizing said measurement in order to tune said mirror to a position of maximum reflection by searching for a position of minimum transmission.

41. The method of claim 40 and wherein said step of searching for minimum transmission is performed by means of a closed loop system for adjusting the applied electrical tuning input to the grating waveguide structure to determine said position of minimum transmission.

42. The method of claim 41, wherein said closed loop system utilizes phase-sensitive-detection of the measurement using an applied AC dither signal.

43. The method of claim 42, wherein said GWS is operated using an applied AC drive voltage, and wherein said dither is said applied AC drive voltage.

44. The method of claim 42, wherein said dither is an externally injected AC signal at a frequency other than that of said applied AC drive voltage, impressed upon the applied AC drive voltage.

45. The method of claim 41, wherein said closed loop system utilizes the detection of the direction of changes in said lasing power resulting from small applied perturbations to said tuning input.
